(19) United States
(12) Patent Application Publication
(10) Pub. No.: US 2026/0036862 A1
(43) Pub. Date: Feb. 5, 2026

(54) HEAD UP DISPLAY WITHOUT MECHANICAL LIGHT BLOCKER

(71) Applicant: Continental Automotive Systems, Inc., Auburn Hills, MI (US)

(72) Inventors: Ricardo Velazquez Vargas, Zapopan (MX); Octavio Arvizu San Vicente, Toulouse Cedex 1 (FR); Oscar Eduardo Beltran Martinez, Guadalajara (MX); Marcelo Vaca Pereira Ghirghi, Tlaquepaque (MX)

(73) Assignee: Continental Automotive Systems, Inc., Auburn Hills, MI (US)

(21) Appl. No.: 18/789,911

(22) Filed: Jul. 31, 2024

(51) Int. Cl. G02F 1/157; G02B 27/01; G02F 1/163

(52) U.S. Cl. CPC G02F 1/157; G02B 27/0101; G02F 1/163

(57) ABSTRACT

An automotive head up display includes a picture generating unit configured to generate a video image to be displayed to a driver as a virtual image on a windshield; an optical system including: a first mirror and a second mirror; the first mirror for guiding the video image from the picture generating unit to a second mirror; the second mirror for guiding the video image from the first mirror to the windshield; at least one electrochromic panel in fluid communication with an ECU, arranged and covering an optical path defined between the windshield and a light output of the picture generating unit; wherein, when the ECU establishes a first condition, the at least one electrochromic panel is energized by an electrical signal and becomes substantially opaque, preventing the passage of solar rays reflected by the second mirror towards the image generating unit.

### TECHNICAL FIELD

The disclosure is related to a head up display system for a vehicle, comprising an electrochromic panel for blocking/reducing the passage of solar rays towards the picture generating unit.

### BACKGROUND

In conventional head up display systems (abbreviated as HUD systems) the display device is placed in a recessed part of the dashboard panel and is thereby concealed from the direct view of the vehicle operator.

The information displayed by the head up display system may be projected onto the windshield of the vehicle so as to present the information in the driver's view while driving. By displaying the information in the driver's view, the driver does not need to look away from the windshield (e.g., toward an instrument display on a center dashboard) while driving to see the presented information.

HUDs producing a distant virtual image usually comprise an optical system to relay a picture from a picture generating unit (PGU). Depending upon the implementation, the optics of the optical system may be composed of glass/plastic lenses, mirrors, or a combination of both.

PGUs can be classified based on the way the image is generated. Direct-view PGUs generate the image directly on the surface observed by the driver, similar to a regular TV. Projection PGUs generate the image using a Spatial Light Modulator (SLM) and project it on a diffuse screen (i-plane or intermediate plane).

This screen is then observed by the driver, wherein the underlying principle is similar to a back-projection TV. The SLM can be a Digital Micro-mirror Device (DMD), Liquid Crystal Display (LCD), Liquid Crystal on Silicon (LCOS), or similar device.

The intermediate image created on the i-plane is observed by the driver through a magnifying optical system comprising at least one aspherical mirror; relaying the magnified and typically also rotated intermediate image onto a combiner. The combining surface can be the vehicle windshield or a dedicated surface in the driver's line-of-sight. This optical system is being referred to as “HUD optics”.

An additional feature of Head Up displays is that the lens or mirror that magnifies the projected image on the windshield has the ability to adjust its tilt using an adjustment mechanism. This mechanical adjustment is made to project the image at different heights and can adapt to the visual field of both tall drivers and short drivers.

However, when a vehicle remains halted for a prolonged period in the sun, such as when parked or in sleep mode, sunlight may enter the lenses, mirrors or combinations of these, eroding their reflective coating and/or directly sending the solar rays to the PGU causing damage to the projector or any other HUD components in the solar ray path.

One solution to sunlight reaching the imaging unit is to extend the tilt range of the lenses and/or mirrors by 15 to 20° more, which translates into a larger HUD system to account for extra space for the mobility of lenses and/or mirrors. Since other systems are around the HUD system, limited space availability in the dashboard panel reduces options which significantly increase the size of the HUD system.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### BRIEF SUMMARY

In view of such problems known from the prior art, a primary object of the present disclosure is to provide a HUD system that can prevent external light, such as sunlight, from entering the optical components and/or the picture generating unit of the HUD system.

The disclosure makes it possible to eliminate or significantly reduce the passage of solar rays to the components of the HUD system without changing the position or size of the optical components even in the event that the design phase of the HUD system has already been completed and the position of disposition within a vehicle has already been established.

According to one embodiment, a head-up display system comprises a picture generating unit, an array of reflective mirrors/lenses that guide the light emitted by the PGU towards the windshield of the vehicle and an electrochromic panel system arranged in the optical path created from the light output of the PGU to the light output of the reflective mirror/lens array.

Electrochromism is a phenomenon in which a material exhibits a reversible electrochemically-mediated change in an optical property when placed in a different electronic state, typically by being subjected to a voltage change. The optical property is typically one or more of color, transmittance, absorbance, opacity, and reflectance. One well known electrochromic material, for example, is tungsten oxide (WO3). Tungsten oxide is a cathodic electrochromic material in which a coloration transition, transparent to blue, occurs by electrochemical reduction.

Electrochromic panels are commonly formed by taking two transparent substrates, such as glass, and depositing a coating. For the panels of the present invention, the coatings on each substrate are electrically conductive and transparent; these materials are referred to as transparent conductors. There may be optional coatings deposited on these transparent conductors, on one or both substrates. With the substrates positioned in a parallel configuration, and with the coatings facing each other, an electrolyte is sandwiched therebetween using a lamination process between the coated substrates. The perimeter is then sealed to encapsulate the layers. A coloration potential is applied between the conducting portions of the substrate coatings. Application of the coloration potential alters the color of the electrochromic panel. i.e. of the aforementioned optional coatings and/or the electrolyte.

A person skilled in the art will appreciate that the devices/systems and methods disclosed herein can be used in numerous embodiments and applications.

### BRIEF DESCRIPTION OF THE DRAWINGS

FIG. 1 shows a side view of a prior art HUD system.

FIG. 2 shows a side view of a prior art HUD system without an electrochromic panel.

FIG. 3 depicts a side view of a HUD system according to a first embodiment of the present disclosure with an electrochromic panel.

FIGS. 4 to 6 are side views that illustrate the variants in which the electrochromic panel(s) can be located along the optical path of the HUD system.

FIG. 7 is a flow chart illustrating a schematic of an example of a process of blocking the passage of solar rays to the vehicle's HUD system using an electrochromic panel according to an embodiment of the present invention.

### DETAILED DESCRIPTION

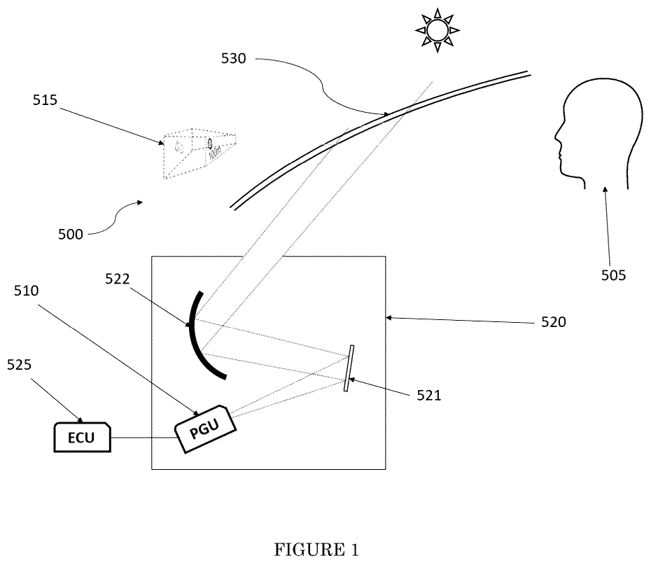

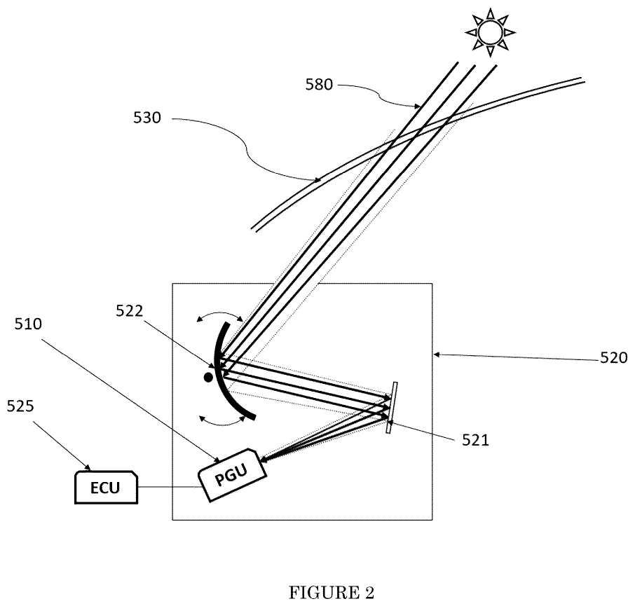

Several illustrative embodiments will now be described with respect to the accompanying drawings, which form a part hereof. While embodiments, in which one or more aspects of the disclosure may be implemented, are described below, other embodiments may be used, and various modifications may be made without departing from the scope of the disclosure or the spirit of the appended claims. FIG. 1 shows a schematic of a prior art HUD system (500) in a vehicle such as an automobile, in which the HUD is arranged on the instrument panel and comprises a picture generating unit “PGU” (510) configured to generate a video image to be displayed to a driver (505) as a virtual image (515) based on vehicle information and the like acquired from the vehicle information acquisition unit (ECU) (525), an optical system (520) formed by a first mirror (521) and a second mirror (522), both configured to guiding the video image from the PGU to a windshield (530) of the vehicle. FIG. 2 shows the same scheme as FIG. 1 where it can visualize the direct passage of solar rays (580) towards the components of the optical system (mirrors 521 and 522) and the PGU (510) of the HUD system (500) when the vehicle is parked or in sleep mode in the sun.

Due to the nature of the second mirror (522), which is preferably concave, the solar rays are reflected and concentrated towards the first mirror (521), which directs the solar rays to the PGU (510). When solar rays enter directly into the HUD system, they cause premature opaqueness of the reflective surfaces of the mirrors, overheating and/or burning of PGU components.

An additional feature of the second mirror (522) is that it has the ability to rotate on one of its axes in such a way that its inclination can vary depending on the height of the driver's field of vision, adjusting the virtual image so that it does not hinder the driver's visibility and/or occupants.

Although the second mirror (522) has the ability to rotate around one of its axes, said angle of rotation is very short and is limited by the space in which the HUD system is housed (shell or case). So, if it's desired to block the entry of the sun's rays by rotating the second mirror (522), a larger space would be required so that the second mirror (522) rotates beyond an optic path towards the first mirror (521) and does not guide the rays towards the other components of the HUD system. Additionally, a second mirror rotation system (NOT SHOWN) would be required to allow an additional range of motion (around 10° to 35° additional).

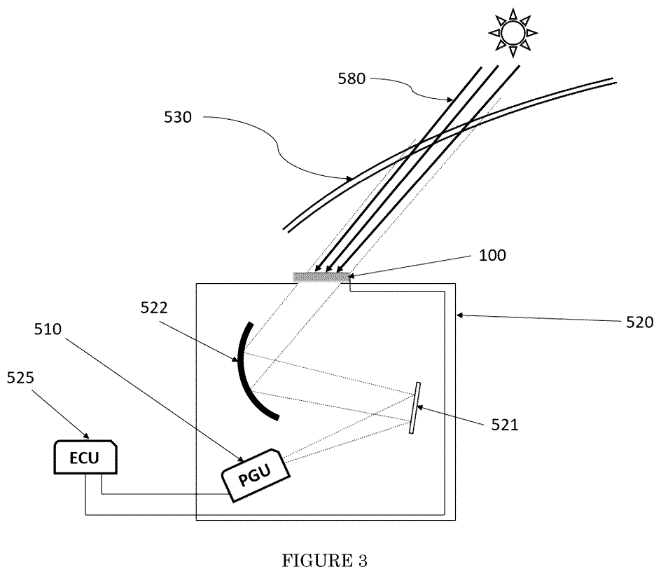

FIG. 3 depicts one embodiment of the present invention with an electrochromic panel (100) that covers the output of the virtual image projected on the windshield (530). Wherein said electrochromic panel (100) is arranged between the windshield (530) of the vehicle and the light output of the virtual image of the HUD system (520).

The electrochromic panel (100) is characterized by its ability to pass or block visible light in response to the application or absence of a voltage. Stated another way, the electrochromic panel (100) will block light when an electric potential is applied across the panel.

In this embodiment, the electrochromic panel (100) is in continuous communication with the vehicle's ECU (525). The ECU (525) is configured to establish a first condition (park mode or sleep mode) and a second condition (driving mode), where in the park/sleep mode it detects that the vehicle is off, stopped in the sun and/or that the PGU (510) is turned off, by a plurality of sensors (a timer, ignition sensor, parking brake sensor, shift lever sensor, light sensor or combinations of these). Once any of these conditions are detected, an electrical signal is subsequently sent to the electrochromic panel (100), where said panel is energized, becoming substantially opaque, changing the light transmittance of the panel, avoiding or substantially reducing the passage of solar rays towards the HUD system (520). In the second condition (driving mode), the plurality of sensors mentioned above detect that the vehicle is on and/or in motion, where the ECU (525) de-energizes the electrochromic panel (100), allowing the virtual image to be projected on the windshield (530) of the vehicle.

An additional feature of the present disclosure is that the ECU (525) incorporates a voltage controller and a memory device. Said memory device contains a database of polarization for electrochromic panel(s) and based on the information received from the plurality of sensors connected to the ECU (525), the voltage controller determines the appropriate degree of polarization to subsequently generate and send an electrical signal to the electrochromic panel (100) in order to apply the determined degree of polarization.

The database is a list of polarization gradients that is defined depending on the time of day, weather, UV index among other conditions, which is fed/updated by connecting a user's mobile device to the vehicle or through a wireless connection of the vehicle to a remote server.

Alternatively, the response to energize the electrochromic panel (100) can be programmed and/or selected manually by the driver in the vehicle's infotainment system or through some button, knob or switch on the dashboard.

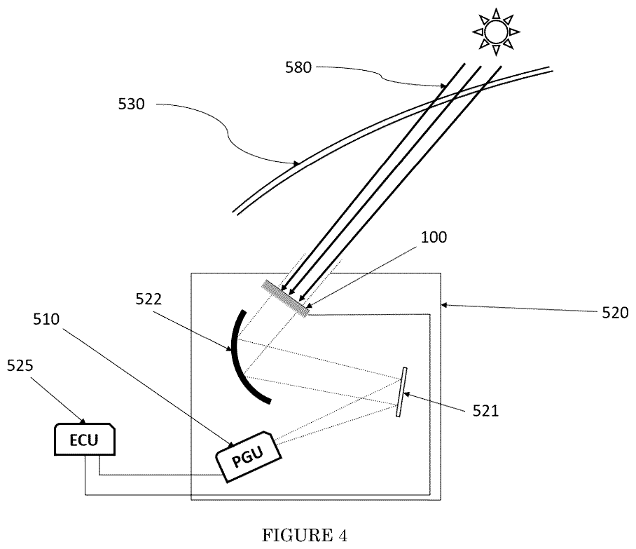

FIGS. 4 to 6 illustrate variants of the embodiment of the present disclosure.

FIG. 4 shows the electrochromic panel activated and arranged in the optical path defined between the second mirror and the light output of the HUD system (520), such that a translucent layer (NOT SHOWN) can be placed at the light output of the HUD system (520) in order to protect the integrity of the electrochromic panel (100) and the rest of the HUD components.

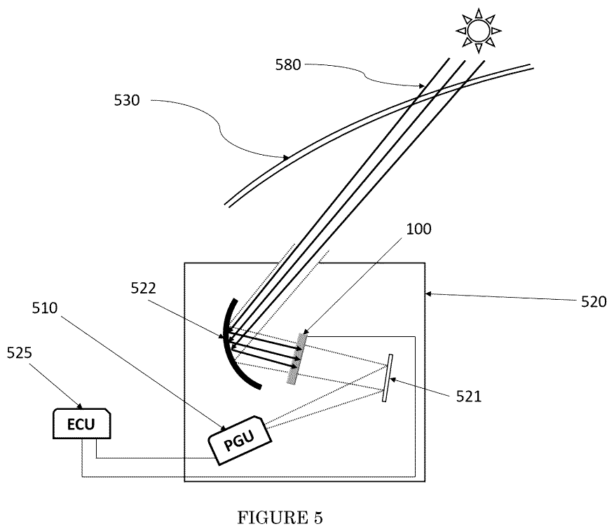

FIG. 5 shows the electrochromic panel (100) activated and arranged in the optical path defined between the second mirror (522) and the first mirror (521).

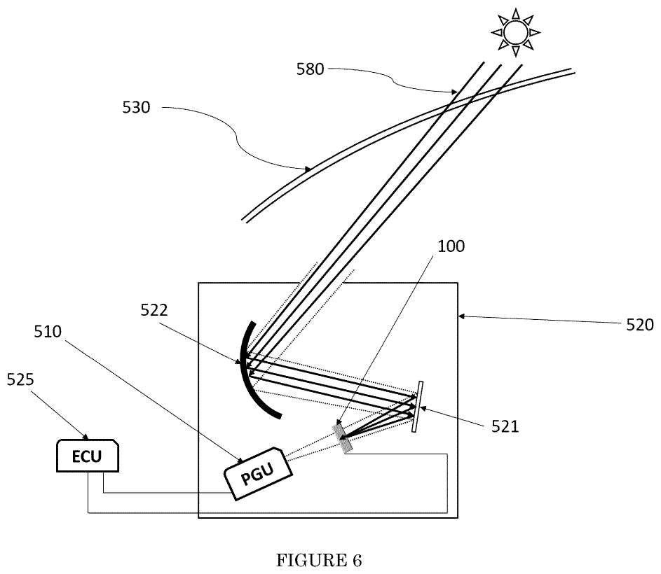

FIG. 6 shows the electrochromic panel (100) activated and arranged in the optical path defined between the first mirror (521) and the PGU (510).

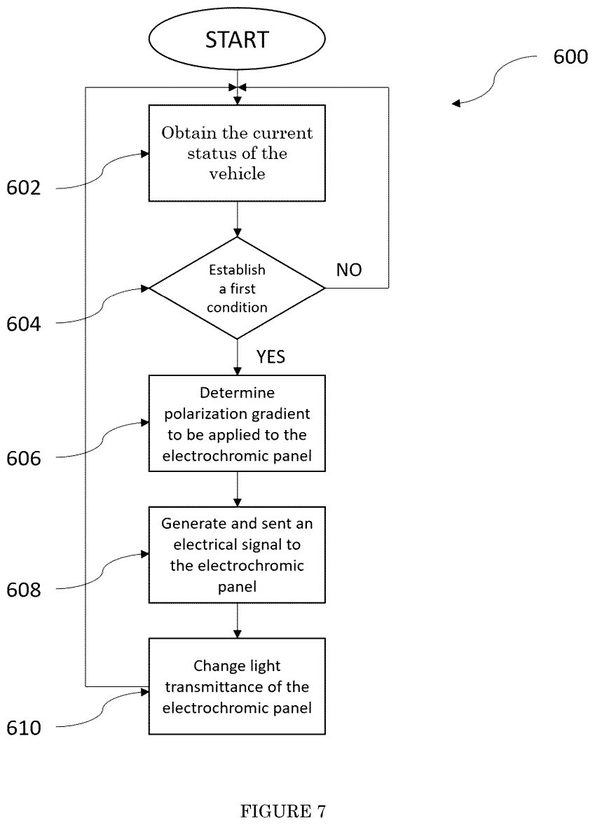

FIG. 7 represents a non-mechanical method (600) to block the passage of solar rays to the vehicle's HUD system using an electrochromic panel. One method is performed by a controller or computer such as the ECU (525) depicted in FIGS. 2 to 3 and described above.

In step 602, the ECU obtains the status of the vehicle through a plurality of sensors (timer, ignition sensor, parking brake sensor, shift lever sensor, light sensor or combinations of these). In step 604 establishes a first condition (park mode or sleep mode) through the status obtained through the plurality of sensors, where said first condition is activated when detecting that the vehicle is off, stopped in the sun and/or that the PGU is off. Once the first ECU condition is established, the list of polarization gradients stored in the voltage controller memory device is consulted at step 606 to determine the polarization gradient to be applied to the electrochromic panel.

In step 608, an electrical signal is generated and sent to at least one electrochromic panel depicted in FIGS. 2 to 3. In step 610, the light transmittance of the electrochromic panel is changed, avoiding or substantially reducing the passage of solar rays to the HUD system.

If the vehicle ECU does not receive at least one signal that the vehicle is off, stopped in the sun and/or that the PGU is off, the method returns to step 602.

While the present invention has been illustrated by a description of various embodiments and while these embodiments have been described in considerable detail, it is not the intention of the applicants to restrict or in any way limit the scope of the appended claims to such detail. Additional advantages and modifications will readily appear to those skilled in the art. The invention in its broader aspects is therefore not limited to the specific details, representative apparatus and method, and illustrative example shown and described. Accordingly, departures may be made from such details without departing from the spirit or scope of applicant's general inventive concept.

1. A head up display system for a motor vehicle, the head up display system comprising:
an ECU configured to establish a first condition through a plurality of sensors;
a picture generating unit configured to generate a video image to be displayed to a driver as a virtual image on a windshield;
an optical system comprising:
a first mirror and a second mirror;
the first mirror configured to guiding the video image from the picture generating unit to a second mirror;
the second mirror configured to guiding the video image from the first mirror to the windshield;
at least one electrochromic panel in fluid communication with the ECU, arranged and covering an optical path defined between the windshield and a light output of the picture generating unit;
wherein, when the ECU establishes the first condition, the at least one electrochromic panel is energized by an electrical signal and becomes substantially opaque, preventing the passage of solar rays reflected by the second mirror towards the image generating unit.

2. The head up display system of claim 1, wherein the plurality of sensor is selected from, a timer, ignition sensor, parking brake sensor, shift lever sensor, light sensor or any combinations thereof.

3. The head up display system of claim 1, wherein the ECU incorporates a voltage controller that determines the degree of polarization applied to the at least one electrochromic panel.

4. A method of non-mechanically blocking the passage of solar rays to a vehicle's HUD system, the method comprising:
obtaining the status of the vehicle through a plurality of sensors;
establishing a first condition by an ECU through the state obtained from the plurality of sensors, wherein the first condition is activated when detecting that the vehicle is off, stopped in the sun and/or that a picture generating unit is off;
consulting a list of polarization gradients stored in a voltage controller memory device;
sending an electrical signal based on the list of polarization gradients to the at least one electrochromic panel avoiding the passage of solar rays reflected by the second mirror towards the picture generating unit when said vehicle is in parking mode or sleep mode.

5. The method of non-mechanically blocking the passage of solar rays to a vehicle's HUD system of claim 4, wherein the plurality of sensor is selected from, a timer, ignition sensor, parking brake sensor, shift lever sensor, light sensor or any combinations thereof.
